(19) United States
(12) Patent Application Publication
(10) Pub. No.: US 2011/0078732 A1
(43) Pub. Date: Mar. 31, 2011

(54) METHOD AND SYSTEM FOR CAUSING A PROMOTED PROGRAM TO BE CAPTURED

(76) Inventor: Alan Gregor Hutohison, Toronto (CA)

(21) Appl. No.: 12/665,889

(22) PCT Filed: Dec. 24, 2008
(86) PCT No.: PCT/CA08/02294

§ 371 Date: Dec. 21, 2009

(51) Int. Cl. H04N 5/445

(52) U.S. Cl. 725/39; 725/38; 725/58; 725/56

(57) ABSTRACT

A method implemented at a network entity. The method comprises receiving an indication of a selection made by a user while the user is viewing a stream of video content, obtaining programming information regarding a program promoted in the stream of video content when the selection was made and causing the program to be captured for the user at least in part on the basis of the programming information regarding the program.

### FIELD OF THE INVENTION

The present invention relates generally to the promotion of television programs and, more particularly, to a method and system for causing a promoted program to be captured for a user.

### BACKGROUND

Television programs are an important source of information and entertainment in today's society. Over the years, different methods of delivering television content have emerged, including delivery via cable and satellite and, more recently, delivery via the Internet (often referred to as video-over-Internet). In a typical situation, a television service provider enters into an agreement with multiple broadcasters and other content providers to deliver their respective television content to the television service provider's customers.

Most of the television content that is provided to customers includes advertisements, which sometimes include advertisements for other programs that the television content provider intends to broadcast at sometime in the future. Unfortunately, if a viewer of an advertisement for a promoted program desires to watch that program, it is often up to the viewer to remember at what time the promoted program is playing, and on what channel it is playing. In some cases this information can then be entered into a recording system, such as a VCR, in order to cause the program to be recorded. However, this requires the user to know when the promoted program is playing, and to go through the time consuming and often complicated procedure of programming the recording device.

One system that attempts to alleviate this problem is called TiVo. TiVo is a digital video recording (DVR) device and system that enables a user to program a set-top unit to record a desired television program. However, a deficiency with this system is that a user is still required to consult a television schedule in order to program the TiVo system to record the desired programs.

Against this background, it can be seen that there is a need in the industry to improve the system and method for recording promoted television programming.

### SUMMARY OF THE INVENTION

In accordance with a first broad aspect, the present invention provides a method implemented at a network entity. The method comprises receiving an indication of a selection made by a user while the user is viewing a stream of video content, obtaining programming information regarding a program promoted in the stream of video content when the selection was made, wherein the program is promoted during a promotional time slot of a television channel, and causing the program to be captured for the user at least in part on the basis of the programming information regarding the program.

In accordance with a second broad aspect, the present invention provides a network entity, comprising a communication unit and a program capturing unit. The communication unit is operative for receiving an indication of a selection made by a user while the user is viewing a stream of video content and obtaining programming information regarding a program promoted in the stream of video content when the selection was made. The program is promoted during a promotional time slot of a television channel. The program capturing unit is operative for causing the program to be captured for the user, at least in part on the basis of the obtained programming information.

In accordance with a third broad aspect, the present invention provides a system comprising a network entity and a capturing device. The network entity comprises a communication unit operative for receiving an indication of a selection made by a user while the user is viewing a stream of video content and obtaining programming information regarding a promoted program in the stream of video content when the selection was made. The program is promoted during a promotional time slot of a television channel. The network entity further comprises a program capturing unit operative for storing program capturing information generated at least in part on the basis of the programming information regarding the program and causing the program to be captured for the user on the basis of the program capturing information. The capturing device is in communication with the network entity and is operative for capturing the program in response to a signal from the program capturing unit.

In accordance with a fourth broad aspect, the invention provides a method implemented at a network entity. The method comprises receiving an indication of a selection made by a user while the user is viewing a stream of video content, obtaining programming information regarding a program promoted in the stream of video content when the selection was made, and causing the program to be recorded for the user at least in part on the basis of the programming information regarding the program.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a block diagram of a television distribution system that provides television services to viewers in accordance with a non-limiting example of the present invention;

FIG. 2 shows a flowchart illustrating a process for causing a promoted program to be captured in accordance with the present invention;

FIG. 3 shows a non-limiting example of an interaction between a network entity, a video content processing device and a user in order to perform the process of FIG. 2;

FIG. 4 shows an alternative non-limiting example of an interaction between a network entity, a video content processing device and a user in order to perform the process of FIG. 2;

FIG. 5 shows a non-limiting example of a program schedule that might be consulted by a service provider when implementing the process of the present invention;

FIG. 6 shows an alternative non-limiting example of an interaction between a network entity, a video content processing device and a user in order to perform the process of FIG. 2;

FIG. 7 shows a block diagram of a television distribution system that provides television services to viewers in accordance with an alternative non-limiting example embodiment of the present invention;

FIG. 8 shows an alternative non-limiting example of an interaction between a network entity, a remote communication device and a user in order to perform the process of FIG. 2; and

FIG. 9 shows a non-limiting example of the contents of a subscriber database in accordance with the present invention.

It is to be expressly understood that the description and drawings are only for the purpose of illustration of certain embodiments of the invention and are an aid for understanding. They are not intended to be a definition of the limits of the invention.

### DETAILED DESCRIPTION

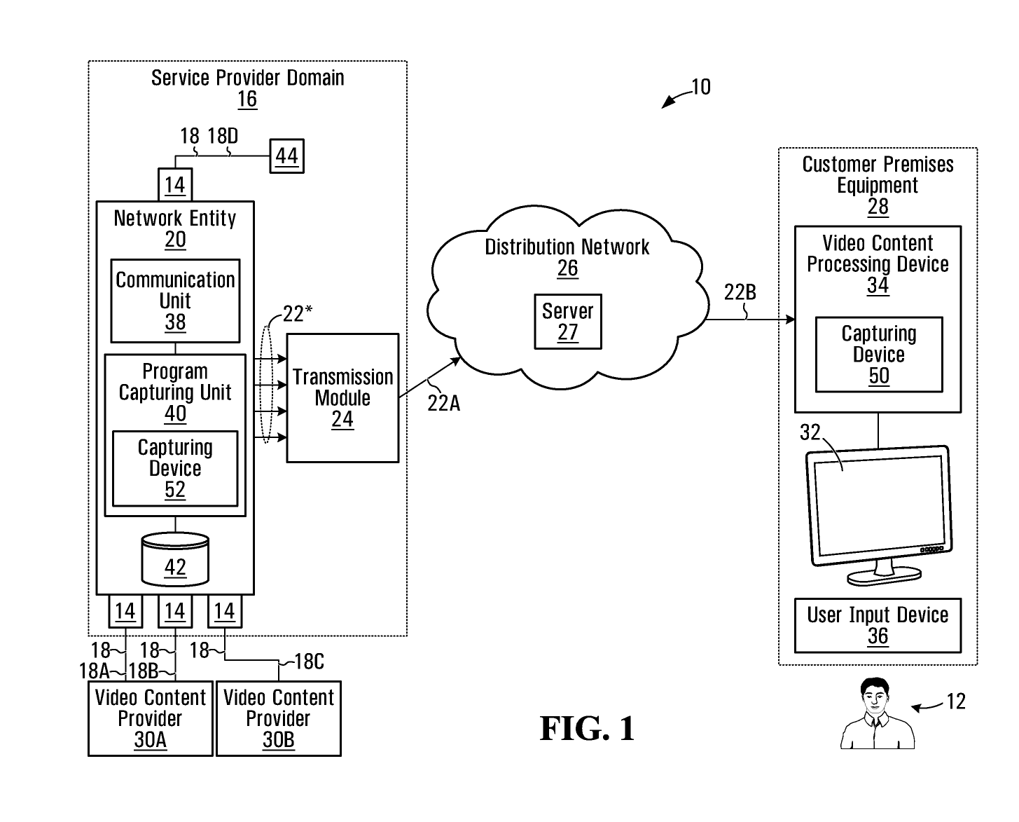

Reference is made to FIG. 1, which is a non-limiting block diagram of a television distribution system 10 that provides television services to a plurality of viewers (although for the purposes of simplicity only one viewer 12 is shown in FIG. 1). By way of example, the television services are provided via scheduled video content on one or multiple content streams (or channels). The television distribution system 10 comprises a service provider domain 16 with various components managed or operated by a television service provider (hereinafter a “service provider”).

The service provider domain 16 includes a network entity 20 that comprises suitable hardware, software, circuitry and/or control logic configured to affect various functions. The network entity 20 has a plurality of inputs 14 that receive content streams 18 supplied by a variety of content providers 30A, 30B, 44. Examples of content providers include, without limitations, broadcasters, studios, advertisers or the service provider itself, to name a few non-limiting possibilities.

The content streams 18 (sometimes referred to as “channels”) may include well known channels such as CBC, CTV, Global, CNN, ABC, CBS, NBC, MSNBC, TSN, HBO and Discovery Channel, as well as other channels carrying scheduled video content (also referred to as “television programs”) of various kinds. The content streams 18 may also include channels that are proprietary to, or affiliated with, the service provider. An example of a proprietary channel is a pay channel, which is rendered available to viewers who pay an additional fee to watch a certain type of programming such as a sports event, music concert or movie, for example.

In the example of FIG. 1, the content streams 18 include a plurality of content streams, in this case content streams 18A, 18B, 18C and 18D. The content streams 18A, 18B and 18C are provided by the content providers 30A, 30B. It is noted that some content providers (such as content provider 30A) may be the source of more than one content stream. In the illustrated non-limiting example, content stream 18A and 18B are supplied by content provider 30A, while content stream 18C is supplied by video content provider 30B.

Content stream 18D is proprietary to the service provider, and is supplied by a content generation module 44 managed and/or operated by the service provider.

The network entity 20 may be configured to organize the content streams 18 for distribution to the viewers 10. For example, the content streams 18 may be formatted, coded, transcoded and/or processed in other ways by the network entity 20 before the resulting content streams (hereinafter called processed content streams and denoted 22*) are provided to a transmission module 24. Additionally, while transforming the content streams 18 into the processed content streams 22*, the network entity 20 may be configured to insert additional information into the content streams 18. Such additional information may include programming information regarding promoted television programs that are scheduled to air at future times or on other channels, as will be discussed below. Such program information is generally received from the video content providers, either at periodic time intervals, or in response to a request. It should be appreciated that in other cases, the network entity 20 does not include programming information regarding promoted television programs in the processed content streams 22*. In such cases, the network entity 20 receives the content streams 18, formats them into the processed content streams 22* and sends the content streams 22* into the distribution network 26, without “knowing” what programming content is contained in the content streams 22*.

The processed content streams 22* are passed from the network entity 20 to a transmission module 24. The transmission module 24 comprises suitable hardware, software, circuitry and/or control logic to output the processed content streams 22* in a format that is convenient for customer premises equipment 28 used by the viewers. In order to send the processed content streams 22* to user premises equipment 28, the transmission module 24 issues the processed content streams 22* through a distribution network 26. The implementation of the transmission module 24 can take on various forms, depending on the nature of the television distribution network 26.

For instance, in the case where the television distribution network 26 is a cable system or a satellite system, the transmission module 24 implements multiplexing, modulation and various other signal processing functions. In this case, the output of the transmission module 24 is a signal 22A (which may be a multi-frequency signal) that is output over a suitable medium (i.e., coaxial cable or radio frequency). At this point, the signal 22A traverses the distribution network 26 on its way to the customer premises equipment 28. In the cable scenario, the distribution network 26 has a tree-like structure, where each branch of the tree terminates at a different customer premises equipment 28 of a different viewer. In the satellite scenario, the distribution network 26 is defined by a coverage area dependent on satellite beams, and viewers with appropriate customer premises equipment 28 will be able to capture the beams and decode the content streams carried therein. In both scenarios, the customer premises equipment 28 comprises a receiver (such as a cable modem or satellite dish) and a video content processing device 34 (which can be implemented as a set top box). In the case of the satellite and cable scenarios, the signal 22B that arrives at the customer premises equipment 28 from the distribution network 26, is the same signal 22A that entered the distribution network 26 from the transmission module 24.

On the other hand, in the case where the television distribution network 26 is an IPTV or mobile wireless system, the transmission module 24 implements packetization and other digital processing functions. The output of the transmission module 24 is a packet stream 22A containing the processed content streams 22*, which is sent over a communication link to a server 27 within the distribution network 26. The server 27 is still under the control of the service provider and is connected to each of the customer premises equipment 28 by a respective logical connection over a packet-switched network, such as the Internet or a wireless network (e.g., Wi-Max, EDGE, EV-DO), for example. In this case, it is the server 27 within the distribution network 26 that determines, on a customer-by-customer basis, which of the processed content streams 22* to send to each customer premises equipment 28 at any given time. As such, in the case of the IPTV scenario, the packet stream 22B that arrives at the customer premises equipment 28 from the distribution network 26 is different from the packet stream 22A that entered the distribution network 26. More specifically, the packet stream 22B contains only the processed content stream 22* (channel), selected by the user 12. This is achieved by interaction between the server 27 and the customer premises equipment 28.

Regardless of the nature of the television distribution network 26, the customer premises equipment 28 comprises a video content processing device 34, (which in the embodiment shown is a television set-top box that can be suitable for satellite, cable or IPTV embodiments, depending on the nature of the television services), and a display device 32.

The video content processing device 34 is operative for receiving the packet stream 22B (which includes one or more of the processed content streams 22*) and for causing a stream (or channel) selected by the user 12 to be displayed on the display device 32. By way of non-limiting example, the display device 32 can be a television monitor or computer screen that is operative for displaying the television programming contained within the content stream 22* for the viewer's benefit.

The customer premises equipment 28 further includes a user input device 36 that is configured to allow the user to interact with the video content processing device 34 to effect a channel change, (i.e. to change the content stream being viewed via the display device 32), to view a programming schedule, or as will be discussed in greater detail below, in order to cause a promoted program to be captured for the user 12. In accordance with a non-limiting embodiment, the user input device 36 is a remote control device. It should, however, be appreciated that other user input devices 36, such as a keyboard, a mouse, a touch sensitive screen or any other known user input device are also included within the spirit of the invention.

In the case of a “channel change command” (or a “content stream change command”) received via the user input device 36, video content processing device 34 (in a cable or satellite scenario) causes a selected content stream to be conveyed to the user 12 via the display device 32. In such a case, the video content processing device 34 selectively filters the signal 22B so as to admit the selected content stream 22*, which is then processed by the video content processing device 34 and output via the display device 32. On the other hand, when the channel change command is received from the user input device 36 in an IPTV or mobile wireless scenario, the video content processing device 34 communicates with the server 27 within the packet-switched distribution network 26 in order to instruct the server 27 to change the content stream 22B being delivered to the customer premises equipment 28 over the appropriate logical connection so that it is thereafter the selected content stream.

In one embodiment, the channel change command received at the video content processing device 34 from the user input device 36 may explicitly convey the identity of the selected content stream, such as “channel 34”. In another embodiment, the channel change command amounts to an “up” or “down” command, or a “switch to previous” command, whereby the selected content stream may be the content stream that had been viewed in the immediate past.

In certain embodiments, the video content processing device 34 may also receive a program schedule from the service provider that can be accessed and viewed by the user 12 of the customer premise equipment 28 via the display 32. The program schedule can be constructed by the network entity 20 based on individual per-channel schedules obtained from the various content providers 30A, 30B, 44 that supply the various content streams 18. The program schedule can be sent to the customer premises equipment 28 with the content stream 22A in an out-of-band fashion, namely along a signal path that is outside content stream 22A and 22B. As such, the program schedule does not interfere with the processed content streams 22* and can be sent to the customer premises equipment 28, regardless of which channel has been selected by the viewer. Alternatively, the program schedule can be included within one or more of the processed content streams 22*.

In general, the program schedule outlines when specific television programs are scheduled to air on specific ones of the content streams 22* (or channels). More specifically, the program schedule outline various television programs scheduled to air on the various content streams 18A, 18B, 18C, 18D that are provided by the service provider. As such, each television program is associated with a specific content stream, a specific begin time and either a specific duration or a specific end time. The format and content of the program schedule can vary greatly, and will be apparent to those of skill in the art.

The user can use the user input device 36 in order to cause the program schedule to be displayed. For example, the user input device 36 may include a dedicated button for causing the program schedule to be displayed on the display 32. When the program schedule is displayed, the user can scroll up or down in order to view the television programming on different content streams 22*. In addition, the user can view the program scheduling at different time slots in order to view upcoming programming. In this manner, the user 12 can interact with the program schedule in order to determine what programs he/she would like to view next or at some other time in the future.

The one or more processed content streams 22* that are delivered to the customer premises equipment 28 within signal 22B generally include advertisement content. The advertisement content may be provided by the video content providers 30A, 30B, 44 within the content streams 18, or in some cases, the network entity 20 may add this advertisement content to the content streams 18 when generating the processed content streams 22*.

The advertisement content that is included within the one or more of the content streams 22* can include advertisements for products (such as dish detergent, cosmetics, cars, etc . . . ) or for services (such as for lawyers, dentists, weight loss services, etc . . . ). In addition, the advertisements can include promotions for upcoming television programming (hereafter to be referred to as promoted programming). The promoted programming can be for television programs, movies, documentaries, or any other type of programming that is being broadcast at a future time and/or on a different channel. In general, this advertisement content can be included within promotional time slots of a television channel. As such, advertisements that promote upcoming programs are broadcast during these promotional time slots of a television channel.

As such, while a user is viewing a television program, such as “Law & Order” on the display 32 of their customer premises equipment 28, the particular video stream 22* that is broadcasting “Law & Order” may include advertisements for other programming. For example, the video stream may include an advertisement for another television program, such as “Lost”, which can be considered a promoted program. Assuming that the television program “Lost” is of interest to the user, in accordance with the present invention, the user can interact with the video content processing device 34 and the network entity 20, for providing an indication of a selection of this promoted program, such that the promoted program is caused to be captured for the user.

As used herein, the term “captured” refers to either:
1) causing the promoted program selected by the viewer to be recorded by a digital recording device, located either locally at the customer premises, or at a network location. In this manner the promoted program is caused to be captured for the user such that the user can then view the recorded program at any desired time or within a predetermined period of time; or
2) causing a channel change, such that the video content processing device 34 causes the channel on which the selected program is playing at the time that the program is playing, to be conveyed to the user on the display 32. In this manner the promoted program is caused to be displayed to a user at the appropriate time.

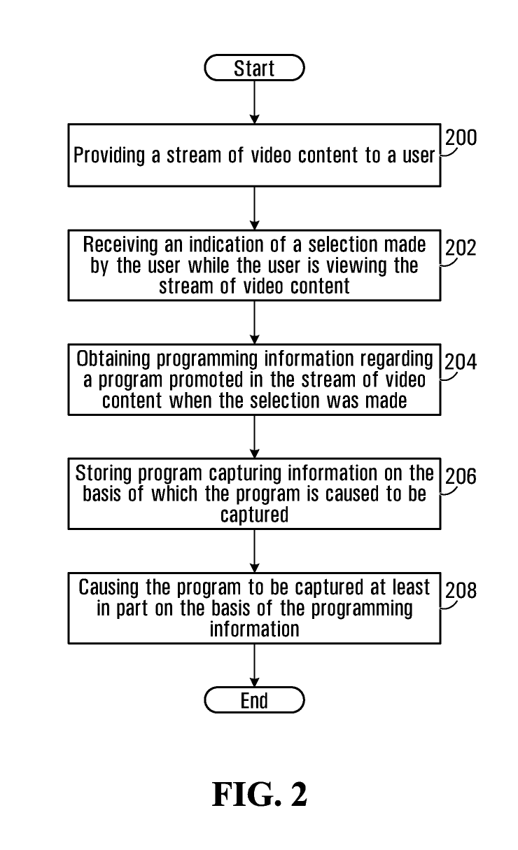

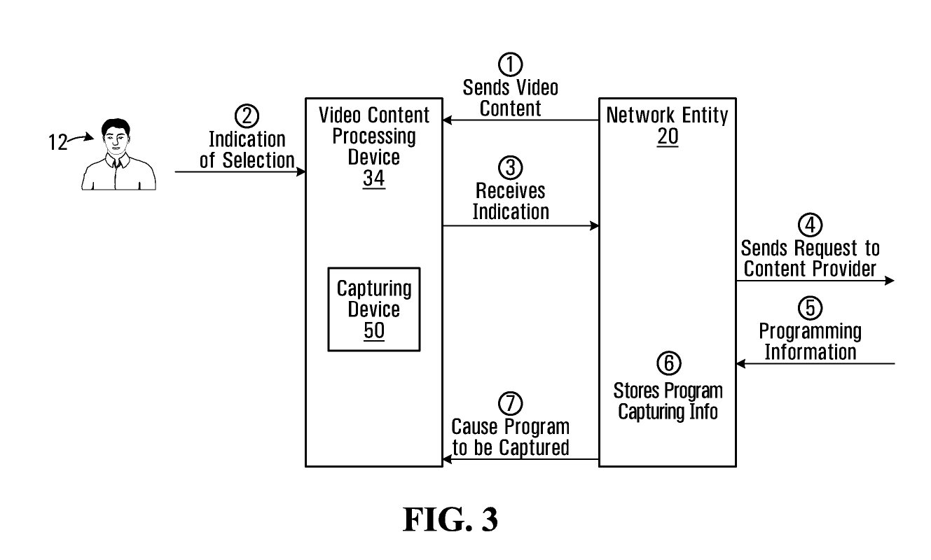

The manner in which the network entity 20 enables a promoted program selected by a user to be captured will now be described in more detail with respect to the flow chart of FIG. 2 and the non-limiting examples of possible interactions between the user 12, the video content processing device 34 and the network entity 20, shown in FIGS. 3-6. For the sake of simplicity, the process described below will be described in the context of user 12. It should however be appreciated that this process could be performed for multiple users at multiple different customer premises equipment 28, all at the same time.

At step 200, the network entity 20 is operative for providing one or more of the processed content streams 22* to the user 12 through the distribution network 26. As mentioned above, in the case of the satellite/cable scenario, the signal 22B that arrives at the customer premises equipment 28 contains multiple content streams 22*, whereas in the case of the IPTV scenario, the signal 22B that arrives at the customer premises equipment 28 contains only the content stream 22* selected by the user 12 for viewing on the display 32.

While user 12 is viewing the television programming contained in the selected content stream 22*, the user 12 is also exposed to the advertising content contained within that selected content stream 22*. Keeping with the example described above, assume that the user 12 is watching “Law & Order”, and during the airing of this television program, advertisement content promoting the television program “Lost” is displayed to the user 12. Assuming that the television program “Lost” is of interest to the user 12, the user 12 can then provide an indication of a selection of this program such that this promoted program is caused to be captured for the user. The user 12 will generally provide the indication of a selection while the advertisement content for the promoted program is playing on the display 32. However, there may be a window of time after the advertisement content has finished playing during which the indication of the selection can still be provided.

The manner in which the user 12 provides the indication of the selection can be performed in a variety of manners. In accordance with a first non-limiting example, the user 12 uses the user input device 36 in order to interact with various menus offered by the video content processing device 34. In one of the menus, the option of selecting a promoted program for capture can be provided. By accepting this option, the user provides an indication of a selection of a promoted program.

For example, the user may first press a “menu” button on the user input device 36, such that a menu is provided to the user 12 on the display 32. The menu may include items such as “view closed captioning”, “wide-screen format” and “capture promoted program”. The user may then use the user input device 36 in order to scroll down to the “capture promoted program” item, and then press a “select” button, in order to select this option. Upon pressing the “select” button, the indication of a selection of a promoted program has been provided by the user 12.

In certain circumstances, once the user has entered the “select” button, the video content processing device 34 may require confirmation from the user 12. As such, an additional display screen may be provided to the user 12 indicating a message, such as “Are you sure you want to capture this program?”, and provide the user with the option of “YES” or “NO”. In this scenario, only upon the user 12 selecting the “YES” option via the user input device 36, is the indication of a selection of a promoted program entered by the user 12.

In accordance with an alternative embodiment, the user input device 36 may include a dedicated button (or other user actuatable input mechanism) for enabling the user 12 to provide an indication of a selection of a promoted program by activating this dedicated button. In such a circumstance, while viewing advertisement content promoting a given program, the user 12 simply needs to activate the dedicated button in order to provide an indication of a selection of the promoted program for capturing. In this manner, the user 12 is provided with a one-step process for providing the indication. Given that advertisement content for a promoted program may not air for very long (15-30 seconds) it may be advantageous to provide a quick and easy way for the user 12 to provide the indication of a selection of a promoted program.

In yet a further embodiment, the user input device 36 may include a microphone capable of receiving a voice input, such that the user 12 simply needs to provide a verbal utterance, such as “capture program”, in order to provide the indication of a selection of the promoted program for capturing. In such an embodiment, the video content processing device 34 or the network entity 20 may include voice recognition software for processing the user's spoken utterance. It should be appreciated that the above examples are provided for illustration only and that other manners of enabling a user to provide an indication of a selection of the promoted programming are included within the scope of the present invention.

Once the user has provided the indication of a selection of a promoted program to be captured, the video content processing device 34 generates a signal for transmission to the network entity 20 indicative of the user's selection of a program to be captured.

The signal generated by the video content processing device 34 may include a variety of information suitable for enabling the network entity 20 to be able to cause the promoted program to be captured. For example, the signal generated may include 1) an identification of the user and/or video content processing device 2) a time stamp indicative of the time at which the user 12 provided the indication and 3) an indication of the content stream 22* (i.e. the channel) that the user 12 was watching when the user 12 provided the indication.

The identification of the user and/or video content processing device 34 from which the signal was transmitted may include a serial number associated with the video content processing device 34, an account number associated with the user's account with the service provider, an IP address or any other unique identifier.

At step 202 of the process, the network entity 20 receives the signal indicative of the selection made by the user while the user was viewing the stream of video content. More specifically, the communication unit 38 receives the signal indicative of the selection made by the user 12.

At step 204, the network entity 20 obtains programming information regarding the program promoted in the stream of video content 22* that was being viewed by the user 12 when the user 12 provided the indication of a selection of a promoted program to be captured.

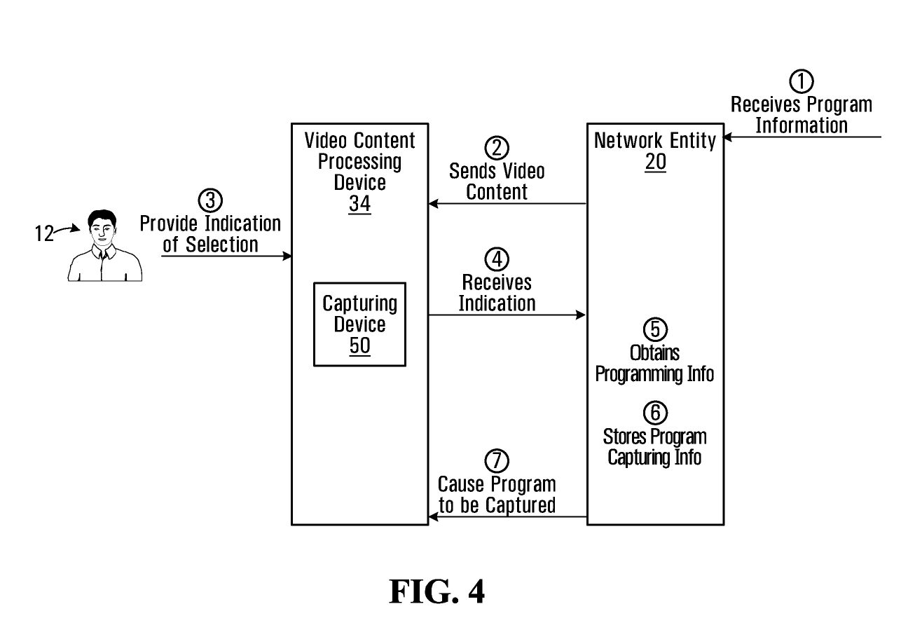

In accordance with the present invention, the step 204 of obtaining programming information regarding the program promoted in the stream of video content 22* can be done in a variety of ways. In accordance with a first non-limiting example, the programming information can be obtained by issuing a request to a video content provider for obtaining programming information associated with the promoted program. In an alternative embodiment, the programming information can be obtained by retrieving the programming information from a memory unit of the network entity 20. Each of these examples will be explained in more detail further below with respect to FIGS. 3 and 4.

Once the program information has been obtained, at step 206, the network entity stores program capturing information that is generated at least in part on the basis of the obtained programming information. It is on the basis of the program capturing information that the promoted program is eventually caused to be captured.

And finally, at step 208, the network entity 20 causes the program to be captured. The promoted program can be captured via a capturing device 50 located at the customer premises equipment 28, or at a capturing device 52 located at the network entity.

Each of the steps of the process shown in FIG. 2, will now be described in more detail with respect to the examples of interaction between the user 12, the video content processing device 34 and the network entity 20 shown in FIGS. 3 and 4.

In FIG. 3, step 200 of providing a stream of video content to the user 12 is illustrated as item 1, wherein the network entity 20 provides video content in the form of one or more of the processed video streams 22*, to the video content processing device 34 at the customer premises equipment 28. This video content is displayed to the user 12 on the display unit 32.

While the user 12 is watching the video content on the display 32, advertisement content for a promoted program may be displayed. In keeping with the example described above, assume that the user 12 is watching “Law & Order”. During the airing of “Law and Order”, advertisement content promoting the television program “Lost” is displayed to the user 12. Assuming that the television program “Lost” is of interest to the user 12, the user 12 provides an indication of a selection of this program, in any of the manners described above. This is illustrated as item 2 in FIG. 3.

Once the user has provided the indication of a selection, the video content processing device 34 generates and transmits a signal to the network entity 20. As such, step 202 of receiving an indication of a selection made by a user is illustrated as item 3 in FIG. 3, wherein the video content processing device 34 receives the signal indicative of a selection made by the user 12 while the user 12 was watching a stream of video content. As mentioned above, the signal received at the network entity 20 may be indicative of an identification of the user and/or the video content processing device 34. Optionally, the signal received at the network entity 20 may also include 1) a time stamp indicative of the time the user entered the indication of a selection; and 2) an indication of the channel (i.e. video stream) that was being watched when the user entered the indication of a selection of a promoted program in the stream of video content. These optional items of information may not be necessary as they can be determined by the network entity 20 without the video content processing device 34 having to provide this information.

In the non-limiting example of interaction shown in FIG. 3, step 204 of obtaining the programming information regarding the program promoted in the stream of video content is illustrated by items 4 and 5, wherein the network entity 20 issues a request to one or more content providers 30A, 30B for obtaining programming information regarding the selected program. The network entity 20 then receives the programming information from the one or more content providers 30A, 30B in response to the request.

The request that is issued by the network entity 20 to the one or more content providers 30A, 30B can be generated on the basis of information contained within the signal indicative of the selection made by the user. For example, let us assume that the user 12 was watching “Law & Order” on Channel 6 on a Wednesday night. At approximately 8:34 pm, advertisement content promoting the television program “Lost” was aired, and the user provided an indication of a selection (item 2 in FIG. 3). A signal indicative of this selection was then generated by the video content processing device 34 and transmitted to the network entity 20 (item 3). The signal generated by the video content processing device 34 included an identification of the user and/or video content processing device 34, as well as a time stamp, indicating 8:34:40 pm, and an indication that the user was watching Channel 6. It should be appreciated that in the case of an IPTV scenario, the video content processing device 34 may not know which channel the user was watching. In such a case, the server 27 may provide to the network entity 20 the information indicative of the channel that the user 12 was watching. On the basis of the information received from the video content processing device 34 (and in some cases the server 27), the network entity 20 is able to generate a request for programming information from one or more of the content providers 30A, 30B.

For example, assuming that the network entity 20 knows that the user was watching Channel 6, and that the indication of a selection was provided at 8:34:40 pm, the network entity 20 may generate a request for an identification of the video content that was shown on Channel 6 at that time, as well as for programming information associated with that video content. The request may be made to all content providers 30A, 30B, or only to the content provider who is responsible for providing the video content for Channel 6.

In accordance with a non-limiting embodiment, the request may only be for an identification of the video content that was airing at exactly 8:34:40 pm, and for programming information associated with that video content. Alternatively, the request may be for an identification of all the video content airing between 8 pm and 9 pm, as well as an indication of the programming information associated with any promoted programs that aired during that time period. It should be appreciated that the request may take on various forms without departing from the spirit of the invention.

For the sake of example, let us assume that the network entity 20 issues a request to the content provider 30A, who is responsible for the video content 18 for Channel 6, requesting an identification of the video content that was airing at exactly 8:34:40 pm, and for programming information associated with that video content.

At item 5 shown in FIG. 3, the network entity 20 receives from the content provider 30A the requested programming information relating to the promoted program. More specifically, in response to the request from the network entity 20, the content provider 30A may return a signal indicating that the video content that was airing at 8:34:40 pm was advertisement content promoting the television program “Lost”. In addition, the returned signal will include programming information for the promoted program. The programming information will generally include the date and time at which the promoted program will be playing, as well as the channel on which the promoted program will be playing. As such, in keeping with the above example, the programming information will be indicative that “Lost” is playing at 10 pm on Saturday on Channel 14.

As such, with respect to the example of implementation shown in FIG. 3, the step 204 of obtaining programming information comprises receiving the programming information in response to a request made to one or more of the content providers 30A, 30B.

At step 206, which is illustrated as item 6 in FIG. 3, the network entity 20 stores program capturing information generated from the obtained programming information, on the basis of which the promoted program is eventually caused to be captured. The program capturing information that is stored at the network entity 20 includes information for enabling a capturing device to be able to capture the promoted program, including at least one condition for causing the promoted program to be captured. The program capturing information may include information including:
a date on which the program is to be captured;
a time at which the program is to be captured;
a channel on which the program is airing;
a capturing device with which the program is to be captured; and
the duration of the program that is to be captured or the stop time at which point the program no longer needs to be captured.

These examples of information are provided for illustrative purposes only, and are not intended to limit the invention in any way. It is within the scope of the present invention for the program capturing information to include any additional information that would be useful.

In keeping with the example described above, the program capturing information may include an indication that at 10 pm on Saturday, July 10, the program airing on Channel 14 is to be captured via capturing device 50 located at the user's customer premises equipment 28. The indication of the capturing device 50 that is to be used for capturing the promoted program may have been provided by the video content processing device 34 in the signal transmitted at item 3. The identification of the capturing device 50 may include a serial number, an IP address, or any other suitable identifier for uniquely identifying, and being able to communicate with the capturing device 50. Alternatively, the identification of the capturing device 50 may be known already at the server level.

At step 208, the network entity 20, and specifically the program capturing unit 40 of the network entity 20, causes the promoted program to be captured. This is done at least in part on the basis of one or more conditions contained within the program capturing information stored at the network entity 20. For example, if the program capturing information indicates that at 10 pm on Saturday, July 10 the promoted program is to be captured, then when 10 pm on Saturday, July 10 arrives, the network entity 20 is triggered to cause the promoted program to be captured. It should be appreciated that the trigger may occur a day, an hour, 15 minutes, or any other time leading up to or including the time at which the promoted program may begin. As such, the trigger can occur at any point prior to the condition contained within the program capturing information being met.

The promoted program can be captured in a variety of different ways. As mentioned above, the term “capturing” can refer to either:
1) causing the promoted program selected by the viewer to be recorded by a digital recording device, located either locally at the customer premises, or at a network location. In this manner the promoted program is caused to be captured for the user such that the user can then view the recorded program at any desired time, or within a predetermined time period.
2) causing a channel change, such that the video content processing device 34 switches to the channel on which the selected program is playing at the time that the program is playing. In this manner the promoted program is caused to be displayed to a user at the appropriate time.

In accordance with a first non-limiting example of implementation, which is shown in FIG. 3 in order to cause the promoted program to be captured, the network entity 20 issues a signal to the video content processing device 34 for causing the capturing device 50 located at the video content processing device 34 to capture the promoted program. As mentioned above, the issuing of the signal to the video content processing device 34 is triggered on the basis of one or more conditions contained within the stored program capturing information. The conditions that could cause the triggering of the signal to the video content processing device 34 can include a time or a date, among other possibilities. The signal that is issued from the network entity 20 to the video content processing device 34 contains instructions for causing the capturing device 50 to capture the program. The instructions could be in the form of executable program instructions, to be executed by the video content processing device 34.

In accordance with a non-limiting example of implementation, the capturing device 50 located at the video content processing device 34 is a digital video recorder that is capable of recording video content contained in the video content stream 22B. Upon receipt at the video content processing device 34 of the signal from the network entity 20, the capturing device 50 is operative for recording the video content specified in the instructions from the network entity 20. In keeping with the example described above, the signal that is issued from the network entity 20 to the video content processing device 34 is indicative that the video content on Channel 14 should be captured between 10 pm and 11 pm. Alternatively, the signal from the network entity 20 to the video content processing device 34 is indicative that the video content on Channel 14 should be captured for 1 hour starting at 10 pm. In the case where the signal from the network entity 20 to the video content processing device 34 is not sent on the exact date that the recording should take place, then the signal may also be indicative of the date on which the recording should take place.

Once the promoted program has been recorded by the capturing device 50 at the video content processing device 34, the user 12 can then access this recorded video content at any time in order to view the recorded program. For example, the user may use the user input device 36 in order to interact with menu items for calling up, and selecting a recorded program to be viewed.

In accordance with an alternative non-limiting example of implementation, the capturing device 50 located at the video content processing device 34 is a device operative for causing an automatic channel change upon receipt of a signal from the network entity 20. In such a scenario, the signal issued from the network entity 20 includes instructions indicative of a channel that should be displayed to a user at a given time. In keeping with the example described above, the signal that is issued from the network entity 20 to the video content processing device 34 can be issued at exactly 10 pm and include instructions for causing the capturing device 50 to cause the video content on Channel 14 to be displayed to the user 12 upon receipt of the signal. Alternatively, the signal from the network entity 20 can be issued to the video content processing device 34 prior to 10 pm, and include instructions for causing the capturing device 50 to cause the video content on Channel 14 to be displayed to the user 12 at 10 pm. In the case where the signal from the network entity 20 to the video content processing device 34 is not sent on the exact date that the capturing should take place, then the signal may also be indicative of the date on which the capturing device 50 should cause the video content on Channel 14 to be displayed to the user 12.

In a further alternative, instead of causing an automatic channel change, the signal issued from the network entity 20 may be operative for causing the video content processing device 34 to provide a prompt to the user, such that the user then changes the channel to the promoted program. For example, at or prior to the airing of the promoted program, a prompt such as “the program <name of program> is now playing on Channel 14”, or “would you like to change to Channel 14 at this time”, could be displayed to the user. The user may then cause the channel to be changed to the channel on which the promoted program is airing in response to the prompt.

In the example of interaction described above with respect to FIG. 3, it is the capturing device 50 that is located locally at the video content processing device 34 that is operative for capturing the promoted program. In an alternative example of implementation, it is a program capturing device 52 that is located at the network entity 20 that is operative for capturing the promoted program. The program capturing device 52 is operative for receiving a signal from the program capturing unit 40 for causing the promoted program to be captured. As mentioned above, this may involve recording the promoted program at the appropriate time, or issuing a signal to the video content processing device 34 at the appropriate time for causing the video content processing device 34 to display to the user 12 the channel on which the promoted program is playing.

The process of FIG. 2 will now be described with respect to the example of interaction illustrated in FIG. 4.

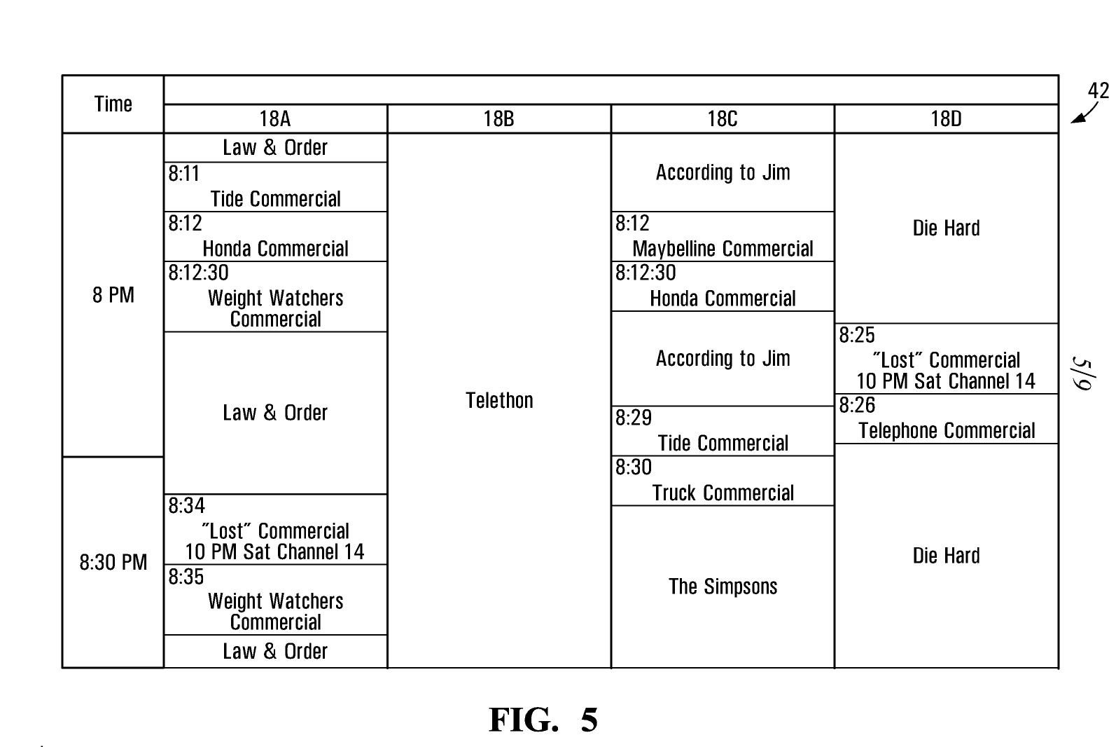

In FIG. 4, the network entity 20 receives programming schedule information from one or more of the video content providers 30A, 30B, which is illustrated as item 1. This programming schedule information can be received at periodic intervals, such as hourly, daily or weekly. Shown in FIG. 5 is a non-limiting example of a programming schedule that is generated on the basis of the received information from all of the video content providers 30A, 30B and 44, showing the programming schedule for all of the video content streams 18a, 18b, 18c and 18d. For ease of example, only the program schedule between the hour of 8 pm and 9 pm is shown. The programming schedule includes an indication of what is airing on each channel, at what time, as well as programming information relating to programs that are promoted in advertising content. As shown in video stream 18A, at 8:34 pm an advertisement for the television program “Lost” is aired. Included within the programming schedule is an indication of the programming information associated with this promoted program. Specifically, the programming information indicates that “Lost” is playing at 10 pm on Saturday on Channel 14.

It should be appreciated that the programming schedule can be provided by the one or more video content providers 30A, 30B, 44 at periodic time intervals, such as hourly, daily, weekly or monthly. In such circumstances, the programming schedule is stored in a memory unit 42 of the network entity 20 such that it can be accessed when needed. As shown in FIG. 4, item 1 illustrates the network entity 20 receiving the programming schedule. In addition, the programming schedule information can be sent to the network entity 20 with the content streams 18 in an out-of-band fashion, namely along a signal path that is outside content stream 18. Alternatively, the programming schedule information can be sent to the network entity 20 from the content providers 30A, 30B and 44 with the content streams 18 in an in-band fashion, namely within the content streams 18.

In FIG. 4, step 200 of providing a stream of video content to the user 12 is illustrated as item 2, wherein the network entity 20 provides video content (the processed video streams 22*) to the video content processing device 34 at the customer premises equipment 28. At item 3 in FIG. 4, the user provides an indication of a selection of a promoted program to be captured. In keeping with the example described above, assume that the user 12 is watching “Law & Order”, and advertisement content promoting the television program “Lost” is displayed to the user 12. Assuming that the television program “Lost” is of interest to the user 12, the user 12 provides an indication of a selection of this program, in any of the manners described above.

The video content processing device 34 then generates and transmits a signal to the network entity 20, shown as item 4 containing an indication of the selection by the user. As such, at step 202 the network entity 20 receives an indication of a selection made by a user. As indicated above, the signal received at the network entity 20 may include 1) an identification of the user and/or video content processing device 2) a time stamp indicative of the time at which the user 12 provided the indication and 3) an indication of the content stream 22* (i.e. the channel) that the user 12 was watching when the user 12 provided the indication.

In the non-limiting example of interaction shown in FIG. 4, step 204 of obtaining the programming information regarding a program promoted in the stream of video content is illustrated by item 5. In this embodiment, the step of obtaining programming information comprises retrieving from the programming schedule that is stored in the memory unit 42 the programming information associated with the promoted program.

The retrieval of the programming information from the memory unit 42 is done at least in part on the basis of information received within the signal indicative of the selection made by the user (item 4). Let us assume that the user provided an indication of a selection (item 3 in FIG. 4) at approximately 8:34 pm, when advertisement content promoting the television program “Lost” was aired on the channel that the user was watching. As such, the signal received at the network entity 20 (item 4 in FIG. 4) indicated that the user 12 provided the indication of a selection at 8:34:40 pm, while the user was watching Channel 6. It should be appreciated that in the case of an IPTV scenario, the video content processing device 34 may not know which channel the user is watching. In such a case, the server 27 may provide information indicative of the channel to the network entity 20. On the basis of this information, the network entity 20 is then able to retrieve the programming information from the programming schedule stored in memory unit 42.

For example, on the basis of the signal indicative of a selection, the network entity 20 knows that the user was watching Channel 6, and that the indication of a selection was provided at 8:34:40 pm. As such, the network entity 20 may access the programming schedule stored in memory unit 42, and determine that at 8:34:40 pm on Channel 6 (which corresponds to content stream 18A) the program “Lost” was being promoted in advertisement content. In addition, included within the programming schedule is programming information regarding the promoted program. In the non-limiting embodiment shown, the programming information is indicative that Lost is being aired at 10 pm on Saturday on Channel 14. This programming information is included within the slot indicating that the television program “Lost” was being advertised at that time.

In an alternative embodiment, the programming information regarding the promoted program is not included within the slot associated with the advertisement for the promoted program. Instead, once the network entity 20 has determined that the program that was being promoted at the time the user 12 provided the indication of a selection is “Lost”, then the network entity 20 can determine from the programming schedule, the programming information associated with “Lost”. For example, by searching the programming schedule for time slots when “Lost” is airing, the network entity can determine the channel and time at which the promoted program will be playing. In this manner, the network entity 20 obtains the programming information from the programming schedule.

Referring back to the flow chart of FIG. 2, once the programming information associated with the promoted program has been obtained by the network entity 20, at step 206, which is illustrated as item 6 in FIG. 4, the network entity 20 stores program capturing information generated from the obtained programming information. This is done in the same manner as described above with respect to FIG. 3.

At step 208, the network entity 20, and specifically the program capturing unit 40 of the network entity 20, causes the promoted program to be captured. This is done at least in part on the basis of one or more conditions contained within the program capturing information stored at the network entity 20.

In the same manner as described above with respect to FIG. 3, the network entity 20 can cause the promoted program to be captured by either the capturing device 50 located at the customer premises equipment 28 or the capturing device 52 at the network entity 20.

### ALTERNATIVE EXAMPLE

### Network Capturing Device

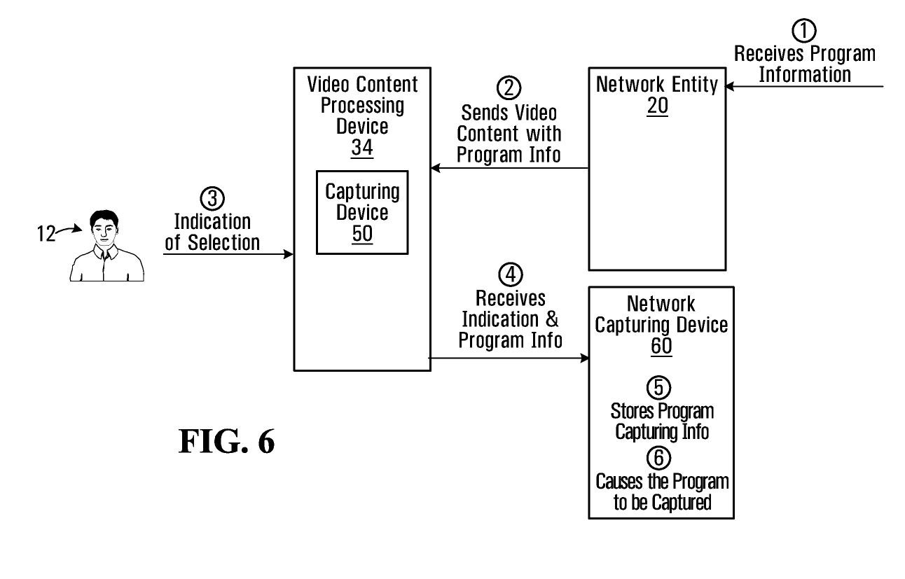

Shown in FIG. 6 is a non-limiting alternative example of an interaction between the user 12 and a network capturing device 60 that is separate from the network entity 20, for causing a promoted program to be captured. In this embodiment, it is the network capturing device 60 that causes the promoted program to be captured. This will be explained in more detail with respect to the process shown in FIG. 2 and the illustration of interaction shown in FIG. 6.

As shown in FIG. 6, the network entity 20 receives programming information, from the video content providers 30A, 30B and 44, which is illustrated as item 1. The programming information generally includes an indication of the date, time and channel at which a promoted program will be airing. This programming information can be embedded within the advertisement slots of the content streams 18A, 18B, 18C and 18D. For example, in the case of advertisement content for the television show “Lost”, included within the advertisement content can be programming information indicating that “Lost” is playing at 10 pm on Saturday night on Channel 14.

The programming information can be provided by the one or more video content providers 30A, 30B, 44 to the network entity 20 whenever the video content 18A, 18B, 18C is provided. This can be done at periodic time intervals, such as hourly, daily, weekly or monthly. In such circumstances, the programming information is stored in a memory unit 42 of the network entity 20 such that it can be accessed when needed.

At step 200, the network entity 20 provides one or more streams 22* of video content to the video content processing device 34, which is illustrated as item 2 in FIG. 6. In this embodiment, the video content 22B that is provided to the video content processing device 34 includes the programming information associated with the promoted programs that are being promoted within advertisement content in the video streams.

At item 3 shown in FIG. 6, the user 12 provides an indication of a selection of a promoted program to be captured. This is done while the user 12 is watching a stream of video content at the user premises equipment 28. In keeping with the example from above, while the user 12 is watching the television program “Law & Order”, an advertisement for the television program “Lost” may be aired. Although not necessarily visible or available to the user 12, included within the advertisement content is the programming information associated with this promoted program, namely “Lost”. The programming information that is embedded within this advertisement content may indicate that “Lost” is playing at 10 pm on Saturday on Channel 14. Assuming that the user is interested in watching the episode of “Lost” that is being promoted in the advertisement content, the user can provide the indication of a selection of this promoted programming. The indication can be provided via the user input device 36 in any of the manners described above with respect to FIGS. 3 and 4.

In order to provide the indication of a selection of the promoted program to be captured, the user 12 is not required to know the programming information relating to the promoted program. In certain cases, the programming information (such as the date and time) may be conveyed to the user during the course of the advertisement for the promoted program. However, the user is not required to provide this programming information when providing the indication of a selection of the promoted program, since the programming information will be obtained without the need for user input.

Once the user 12 has provided the indication of a selection of a promoted program, the video content processing device 34 generates a signal indicative of this selection for transmission to the network capturing device 60, illustrated as item 4. As mentioned above, the video content processing device 34 already has the programming information relating to the promoted program, since this information was received together with the video content 22B (item 2). As such, when generating the signal indicative of the selection to be transmitted to the network capturing device 60, the video content processing device 34 includes this programming information within the signal indicative of a selection of a promoted program to be captured.

Accordingly, the signal generated by the video content processing device 34 that is sent to the network capturing device 60 may include 1) an identification of the user 12 and/or the video content processing device 34 which may include a unique identifier such as an account number, an IP address, etc . . . ; 2) an indication that the user would like a promoted program to be captured; and 3) the programming information relating to the promoted program. As such, in keeping with the above example, the signal from the video content processing device 34 to the network capturing device 60 includes an identification of the user 12 as well as an indication that the user would like the program “Lost” to be captured, which is playing at 10 pm on Saturday on Channel 14. Obviously, the name of the program is not necessary information for the capturing device, and the signal may simply be indicative that video content playing on channel 14 at 10 pm should be recorded.

In accordance with this example of interaction between the user 12, the video content processing device 34 and the network capturing device 60, steps 202 and 204 of the process shown in FIG. 2 are performed substantially simultaneously. More specifically, the network capturing device 60 receives the indication of a selection made by the user and obtains the programming information relating to the promoted program at substantially the same time.

At step 206, which is illustrated as item 5 in FIG. 6, the network capturing device 60 generates and stores program capturing information on the basis of which the promoted program can be captured. The program capturing information that is stored at the network capturing device 60, and includes information for enabling the network capturing device 60 to be able to capture the promoted program. The program capturing information includes at least one condition on the basis of which the network capturing device 60 is caused to capture the promoted program. The program capturing information may include information including:
a date on which the program is to be captured;
a time at which the program is to be captured;
a channel on which the program is airing;
a capturing device with which the program is to be captured;
the duration of the program that is to be captured, or the stop time at which point the program no longer needs to be captured; and
an identification of the user 12 or customer premises equipment 28 that will be associated with the captured program.

These examples of information are provided for illustrative purposes only, and are not intended to limit the invention in any way. It is within the scope of the present invention for the program capturing information to include any additional information that would be useful for capturing the promoted program

In keeping with the example described above, the program capturing information may include an indication that user 12 associated with a given customer account number (or any other unique identifier), would like the program “Lost, which is airing at 10 pm on Saturday, July 10, on Channel 14 to be captured by the network capturing device 60.

Finally, at step 208, which is illustrated as item 6 in FIG. 6, the network capturing device 60 causes the promoted program to be captured. This is done at least in part on the basis of one or more conditions contained within the program capturing information stored at the network capturing device 60. For example, if the program capturing information indicates that at 10 pm on Saturday, July 10 the promoted program is to be captured, then when 10 pm on Saturday, July 10 arrives, the network capturing device 60 is triggered to cause the promoted program to be captured. It should be appreciated that the trigger may occur a day, an hour, 15 minutes, or any other time leading up to or including the time at which the promoted program may begin. As such, the trigger can occur at any point prior to the condition contained within the program capturing information being met.

There are a variety of ways for the network capturing device 60 to cause the promoted program to be captured. In accordance with a first non-limiting example, the network capturing device 60 can capture the promoted program itself, and in a second non-limiting example, the network capturing device 60 can issue a signal to a capturing device 50 located within the video content processing device 34 to capture the promoted program. Each of these will be discussed below in more detail.

In accordance with the first non-limiting example, wherein it is the network capturing device 60 that is operative for capturing the promoted program, the network capturing device 60 is a digital video recorder that is capable of recording video content contained in the video content stream 22B. In this embodiment, the network capturing device 60 is in communication with either the video content providers 30A, 30B directly for receiving the video content streams 18, or the network capturing device 60 is in communication with the transmission module 24 of the service provider domain 16 for receiving the processed video content signals 22*. It is possible that the network capturing device is included within the service provider domain 16 and is controlled and operated by the service provider.

In such an embodiment, when one or more conditions contained within the stored program capturing information are met, the network capturing device 60 is caused to start recording the video content corresponding to the promoted program. The conditions that could trigger the network capturing device 60 to start recording can include a time or a date, among other possibilities.

Once the promoted program has been recorded by the network capturing device 60, the user 12 can then access this recorded video content at any time, or within a predetermined time, in order to view the recorded program. For example, the user may use the user input device 36 in order to interact with menu items for calling up, and selecting a recorded program to be viewed from the network capturing device 60.

In accordance with the second non-limiting example, the network capturing device 60 can issue a signal to a capturing device 50 located at the customer premises equipment 28 instructing the capturing device 50 to capture the promoted program. In this embodiment, the network capturing device 60 issues a signal to the video content processing device 34 for causing a capturing device 50 to capture the promoted program. As mentioned above, the issuing of the signal to the video content processing device 34 is triggered on the basis of one or more conditions contained within the stored program capturing information. The conditions that could trigger the signal to be sent to the video content processing device 34 can include a time or a date, among other possibilities. The signal that is issued from the network capturing device 60 to the video content processing device 34 contains program instructions for causing the capturing device 50 to capture the program. The instructions could be in the form of executable program instructions, to be executed by the video content processing device 34.

As described above with respect to FIGS. 3 and 4, the capturing device 50 located at the video content processing device 34 can be a digital video recorder capable of recording video content contained in the video content stream 22B. As such, upon receipt at the video content processing device 34 of the signal from the network capturing device 60, the capturing device 50 is operative for recording the video content specified in the instructions in the signal.

Once the promoted program has been recorded by the capturing device 50 at the video content processing device 34, the user 12 can then access this recorded video content at any time, in order to view the recorded program. For example, the user may use the user input device 36 in order to interact with menu items for calling up, and selecting a recorded program to be viewed.

In accordance with an alternative non-limiting example of implementation, the capturing device 50 located at the video content processing device 34 is a device operative for causing an automatic channel change upon receipt of a signal from the network capturing device 60. In such a scenario, the signal issued from the network capturing device 60 includes instructions indicative of a channel that should be displayed to a user at a given time.

Alternatively, and as described above, upon receipt of a signal from the network capturing device 60, the video content processing device 34 may cause a prompt to be displayed to a user, such that the user is prompted to change the channel to the promoted program. For example, at or prior to the airing of the promoted program, a prompt such as “the program <name of program> is now playing on Channel 14”, or “would you like to change to Channel 14 at this time”, could be displayed to the user. The user may then cause the channel to be changed to the channel on which the promoted program is airing. As such, in the embodiment shown in FIG. 6, it is the network capturing device 60 that is located separately from the network entity 20 that is operative for causing the promoted program to be captured.

### ALTERNATIVE EXAMPLE II

### Login Feature

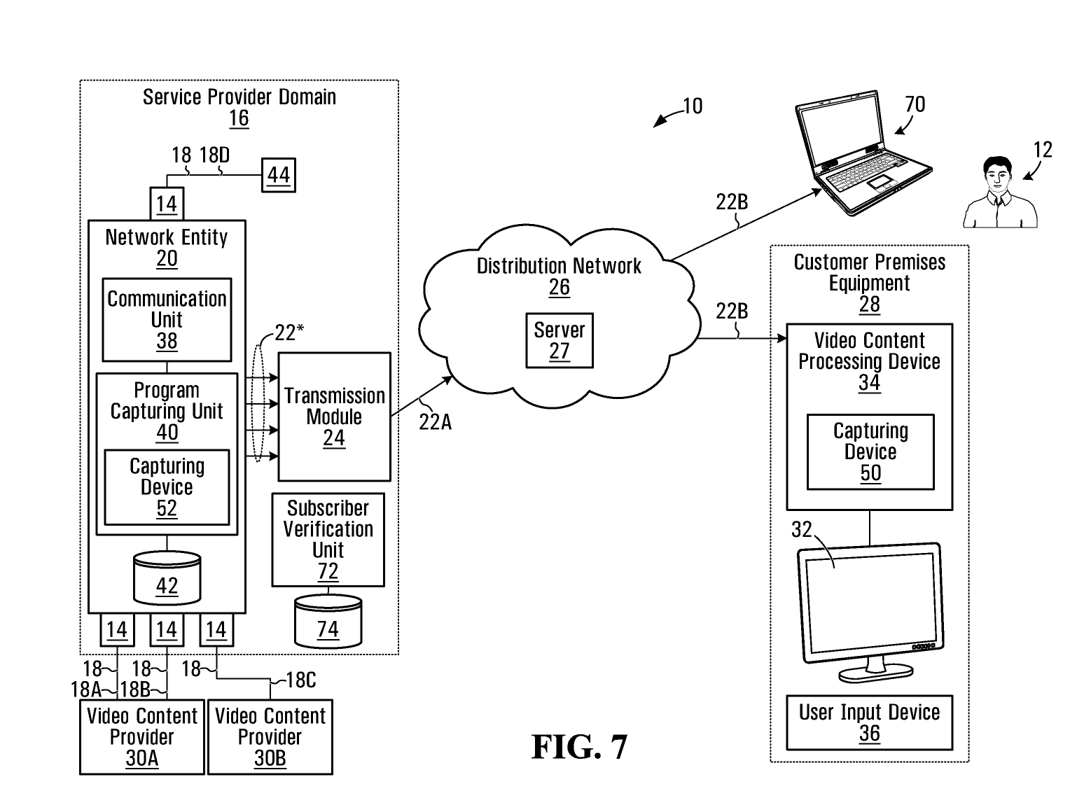

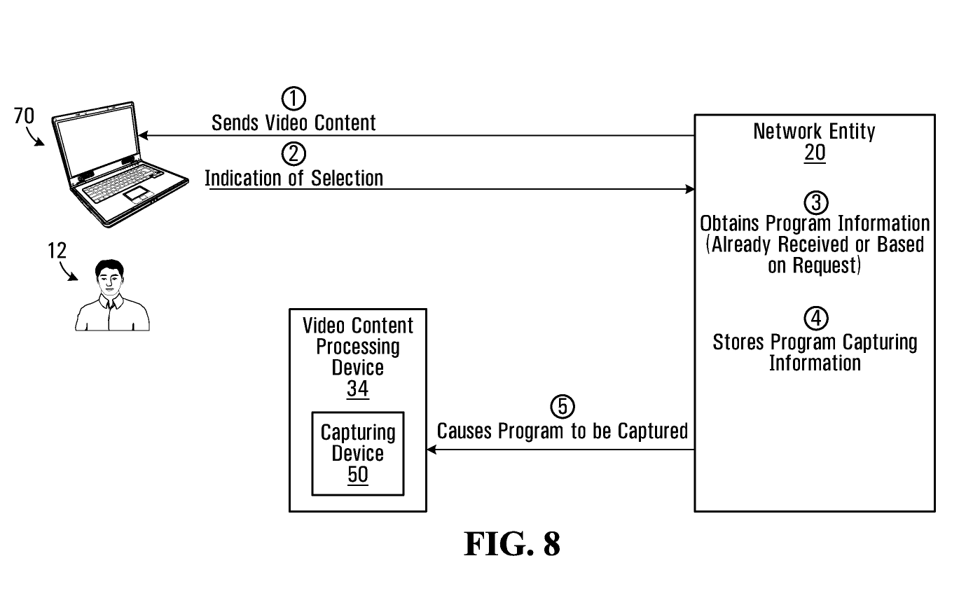

Shown in FIGS. 7 and 8 is a further non-limiting example of implementation of the present invention, wherein a user is able to interact with the network entity 20 via a remote communication device 70 in order to view video content provided by the network entity 20 on the remote communication device 70.

Shown in FIG. 7 is a television distribution network 10 similar to that of FIG. 1, with like components identified with like reference numbers. However, in this example of implementation, the user 12 is able to interact with the network entity 20 via a remote communication device 70, and the service provider domain 16 further comprises a subscriber verification unit 72 for verifying whether the user 12 is authorized to receive video content from the network entity 20 at the remote communication device 70.

In the example shown, the remote communication device 70 is a laptop computer, however it should be appreciated that the remote communication device 70 could be any device capable of being connected to the distribution network, and specifically to a packet switched network, such as a desktop computer, a video enabled smart-phone, a video enabled iPod, etc. This embodiment is particularly applicable to IPTV services, wherein the remote communication device 70 is operative for connecting to the server 27 of the packet-switched network, for being able to receive IPTV packet streams 22B containing video content.

In this manner, a user of the remote communication device 70 is able to access the service provider domain 16 via a packet switched network (such as the internet) for receiving video content from the service provider. In order to be able to access and receive video content 22B at the remote communication device 70, the user 12 will need to be authenticated by a subscriber verification unit 72 that verifies whether the user 12 is authorized to receive video content from the network entity 20. For example, in order to be authorized, the user must either be a subscriber to the service provider's services, such that the user has an account profile with the service provider, or the user 12 must provide payment information (such as credit card information) such that the user can obtain the IPTV services on a pay-as-you-go basis.

In the case where the user 12 has an account profile with the service provider, the user's account profile information may be stored in a subscriber database. For example, as shown in FIG. 7, the subscriber verification unit 72 is in communication with a subscriber database 74. The database 74 of subscribers may be stored within a memory unit of the subscriber verification unit 72, or the subscriber database 74 may be stored at one or servers that are accessible by the subscriber verification unit 72.

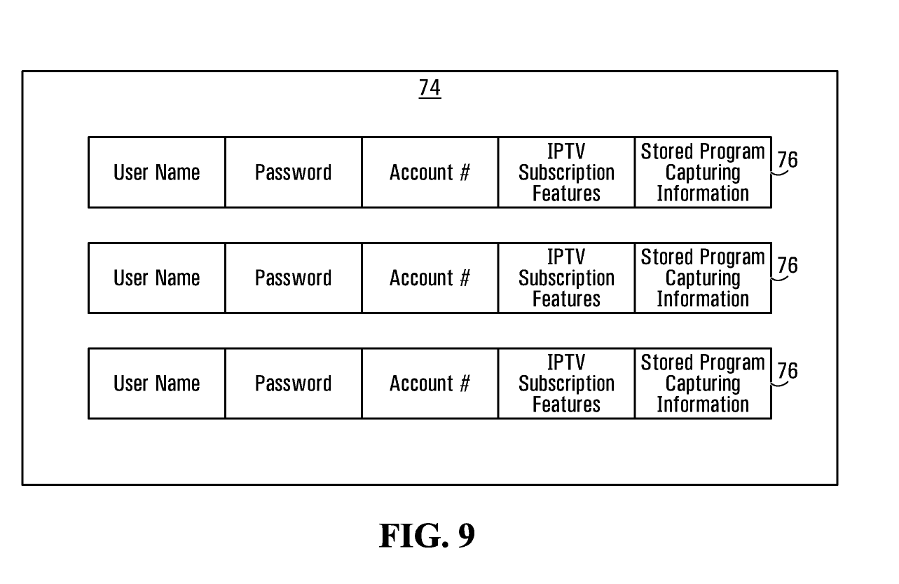

Shown in FIG. 9 is a non-limiting example of the contents of the subscriber database 74 in accordance with the present invention. As shown, the subscriber database 74 includes a plurality of entries 76 each associated to a respective subscriber. Each entry 76 includes an indication of a user name, a password associated with the user name, an account number or other unique identifier for identifying the user and/or the user's video content processing device 34, a list of IPTV features subscribed to by the user, as well as an indication of the stored program capturing information associated with promoted programs that the user has indicated should be captured.

When initiating a subscription, the user can configure some of the information contained within his/her associated entry 76. For example, the user can select a user name and password that will be used for verification purposes. The user can also provide an indication of certain IPTV features, such as the capturing device that the user would like to have capture promoted programs that have been selected. For example, the user 12 may specify that the selected programs should be captured by the capturing device 50 at his/her customer premises equipment 28, or the user 12 may specify that the selected programs should be captured by the capturing device 52 at the network entity 20.

These examples of information included within the subscriber database are for illustrative purposes only, and are not intended to limit the invention in any way. It is within the scope of the present invention for the subscriber database 74 to include additional information associated with the subscriber that is not shown in FIG. 9. For example, each entry might include a list of “friends” with whom the user 12 would like to share information pertaining to the capturing of the promoted program.

Although the subscriber database 74 is depicted in FIG. 8 as being one component, the database 74 may be distributed in nature. For example, the database 74 can have portions of its content stored in different data storage media possibly located in different network components of the service provider domain 16.

Referring back to FIG. 7, when the user 12 would like to receive IPTV video content from the service provider at his/her remote communication device 70, the user 12 first connects the remote communication device 70 to a packet-switched network, such as the internet. This may be done via a cable connection, or via a wireless connection.

Once connected to the packet-switched network, the user then connects to the service provider domain 16 so as to be able to authenticate himself/herself as a subscriber to the IPTV services. In accordance with a first non-limiting example, the user can use a web-browser program in order to access a web-page allowing the user to “login” to the service provider domain 16. For example, the web-page may ask the user 12 for his/her “username” and “password”. The user can enter this information in the appropriate fields of the web-page via a keypad, mouse, touch-sensitive screen, microphone, or any other suitable input device known in the art. Once entered, the user may then cause this information to be sent to the subscriber verification unit 72 by clicking on a <send> button, a <submit> button or an <enter> button.

Alternative, instead of the user having to enter “login” information, the user may be automatically logged in. This may be done on the basis of a cookie, or device credentials (such as MAC ID, electronic serial number or any other hardware identifier).

Upon receipt at the subscriber verification unit 72 of this login information, the subscriber verification unit 72 accesses the subscriber database 74 in order to determine if the user 12, is in fact a subscriber. In order to do so, the subscriber verification unit 72 looks for a match between the user name and password provided by the user 12, and a username and associated password contained within an entry 76 contained in the subscriber database 74.

Upon verification that the user 12 is, in fact, a subscriber to the IPTV services, the subscriber verification unit 72 is able to issue a signal indicating to the network entity 20 to provide the remote communication device 70 with a stream of video content 22B through the server 27 in the packet-switched network portion of the distribution network 26. In this manner, the user is able to view television programming on his/her remote communication device 70.

The method outlined in FIG. 2 will now be described in more detail with respect to the non-limiting example of implementation shown in FIGS. 7 and 8. More specifically, with reference to FIG. 8, step 200 of providing a stream of video content to a user is illustrated as item 1. In this embodiment, the network entity 20 provides the stream of video content 22B to the user 12 at the remote communication device 70.

While the user is watching the stream of video content 22B on his/her mobile communication device, the user may be presented with advertisement content for promoting different programs. When the user 12 views an advertisement for a promoted program that is of interest, the user 12 can provide an indication of a selection of the promoted program. For example, while the user 12 is watching the program “Law and Order”, an advertisement for “Lost” may be aired. Assuming that the user 12 is interested in watching “Lost”, the user 12 can provide an indication of a selection of the promoted program. This can be done via any appropriate user input device associated with the remote communication device 70. For example, the user 12 may provide the indication via a keypad, a keyboard, a touch sensitive screen, a mouse, a pointing device, a microphone, or any other possible user input device.

Once the user 12 has provided the indication of a selected promoted program, the remote communication device 70 generates a signal for transmission to the network entity 20 indicative of the indication provided by the user 12. In accordance with a non-limiting example of implementation, in order for the remote communication device 70 to be able to generate a signal for transmission to the network entity 20 on the basis of the indication provided by the user, the remote communication device 70 will require an appropriate software package. This software package can be provided to a user 12 when the user subscribes to the IPTV service (such as via a CD for example) or this software can be downloaded as a patch from the service provider website.

The signal generated by the remote communication device 70 for transmission to the network entity 20 may include 1) an identification of the user 12, which may include a unique identifier such as an account number, an IP address, etc . . . ; 2) an indication that the user would like a promoted program to be captured; 3) a time stamp associated with the user providing the indication and 4) in some cases, an indication of the capturing device for capturing the promoted program. As such, in keeping with the above example, the signal from the remote communication device 70 to the network entity 20 includes an identification of the user 12 as well as an indication that the user would like the program “Lost” to be captured.

As illustrated as item 2 in FIG. 8, once generated, the signal indicative of the selection is transmitted from the remote communication device 70 to the network entity 20.

At step 202 the network entity 20 receives the indication of a selection made by the user 12, while the user 12 was watching a stream of video content 22B on the remote communication device 70.

At step 204, which is illustrated as item 3 in FIG. 8, the network entity 20 obtains programming information regarding the promoted program. It should be appreciated that the network entity 20 can obtain the programming information in any of the manners described above with respect to FIGS. 3 and 4. More specifically, in accordance with a first non-limiting example, the network entity 20 can obtain the programming information regarding the promoted program in response to a request issued to one or more of the video content providers 30A, 30B. In accordance with a second non-limiting example, the network entity 20 can obtain the programming information regarding the promoted program by accessing a programming schedule provided to the network entity 20 by the video content providers 30A, 30B at periodic time intervals. The programming schedule may include the programming information that can be accessed by the network entity 20, or the network entity 20 can derive the programming information on the basis of the programming schedule.

At step 206, which is illustrated as item 4 in FIG. 8, the network entity 20 stores program capturing information on the basis of which the promoted program is caused to be captured. The program capturing information that is stored at the network entity 20 includes information for enabling a capturing device to be able to capture the promoted program. For example, the program capturing information may include information including:
a date on which the program is to be captured;
a time at which the program is to be captured;
a channel on which the program is airing;
a capturing device with which the program is to be captured; and
the duration of the program that is to be captured or the stop time at which point the program no longer needs to be captured.

These examples of information are provided for illustrative purposes only, and are not intended to limit the invention in any way. It is within the scope of the present invention for the program capturing information to include any additional information that would be useful.

In keeping with the example described above, the program capturing information may include an indication that at 10 pm on Saturday, July 10, the program “Lost” airing on Channel 14 is to be captured via capturing device 50 located at the user's customer premises equipment 28. Obviously, the name of the program is not necessary information for the capturing device, and the signal may simply be indicative that video content playing on channel 14 at 10 pm should be recorded. The identification of the capturing device 50, may include a serial number, an IP address, or any other suitable identification technique for uniquely identifying, and being able to communicate with the capturing device 50.

At step 208, the network entity 20, and specifically the program capturing unit 40 of the network entity 20, causes the promoted program to be captured. This is done at least in part on the basis of one or more conditions contained within the program capturing information stored at the network entity 20. For example, if the program capturing information indicates that at 10 pm on Saturday, July 10 the promoted program is to be captured, then when 10 pm on Saturday, July 10 arrives, the network entity 20 is triggered to cause the promoted program to be captured. It should be appreciated that the trigger may occur at any time prior to the condition contained within the program capturing information being met. It should be appreciated that the trigger may occur a day, an hour, 15 minutes, or any other time leading up to or including the time at which the promoted program may begin. As such, the trigger can occur at any point prior to the condition contained within the program capturing information being met.

In order to cause the promoted program to be captured, the network entity 20 must determine which capturing device will be used to capture the promoted program, which will be either the capturing device 50 located at the customer premises equipment 28 associated with the user, or the capturing device 52 located at the network entity 20. This can be determined in a variety of ways. As mentioned above, the signal issued from the remote communication device 70 to the network entity 20 may include an indication of which capturing device should be used to capture the promoted program. Alternatively, this information may be obtained in the entry 76 associated with the user 12 stored in the subscriber database 74. In such an embodiment, on the basis of the identification of the user 12 received in the signal from the remote communication device 70, the network entity 20 can communicate with the subscriber verification unit 72 for accessing the entry 76 associated with the user 12 and determining which capturing device should be used.

In accordance with a first non-limiting example of implementation, which is shown in FIG. 8, it is the capturing device 50 located at the customer premises equipment 28 that is used to capture the promoted program. As such, in order to cause the program to be captured, the network entity 20 issues a signal to the video content processing device 34 for causing a capturing device 50 located at the video content processing device 34 to capture the promoted program. As mentioned above, the issuing of the signal to the video content processing device 34 is triggered on the basis of one or more conditions contained within the stored program capturing information. The conditions that could cause the triggering of the signal to the video content processing device 34 can include a time or a date, among other possibilities. The signal that is issued from the network entity 20 to the video content processing device 34 contains instructions for causing the capturing device 50 to capture the program. The instructions could be in the form of executable program instructions, to be executed by the video content processing device 34.

The capturing device 50 located at the video content processing device 34 can be a digital video recorder that is capable of recording video content contained in the video content stream 22B. Upon receipt at the video content processing device 34 of the signal from the network entity 20, the capturing device 50 is operative for recording the video content specified in the instructions from the network entity 20. Once the promoted program has been recorded by the capturing device 50 at the video content processing device 34, the user 12 can then access this recorded video content at any time or within any predetermined time, in order to view the recorded program.

In the case where the user wishes to access the recorded video content using the remote communication device 70, the user may cause the remote communication device 70 to issue a signal to the network entity 20, which in turn retrieves the stored video content from the video content processing device 34 and forwards that video content to the remote communication device 70.

Alternatively, the network entity 20 may cause a capturing device (not shown) located at the remote communication device 70 to provide a prompt (in the form of a pop-up, or some other graphical prompt) for causing the user to change channels on his/her remote communication device 70. In some cases, the network entity 20 may issue a signal to the capturing device at the remote communication device 70 to cause an automatic channel change at the remote communication device 70. Specifically, the channel may be changed to the channel airing the promoted program at the time when the promoted program is airing. In such a scenario, the signal issued from the network entity 20 includes instructions indicative of a channel that should be displayed to a user at a given time.

In accordance with a second non-limiting example of implementation, it is the capturing device 52 located at the network entity 20 that is used to capture the promoted program. The program capturing device 52 is operative for receiving a signal from the program capturing unit 40 for causing the promoted program to be captured. As mentioned above, this may involve recording the promoted program at the appropriate time, or issuing a signal to the video content processing device 34 associated with the user 12 at the appropriate time for causing the video content processing device 34 to display to the user 12 the channel on which the promoted program is playing.

Those skilled in the art will appreciate that in some embodiments, the functionality of the network entity 20 and the subscriber verification unit 72 may be implemented using pre-programmed hardware or firmware elements (e.g., application specific integrated circuits (ASICs), electrically erasable programmable read-only memories (EEPROMs), etc.), or other related components. In other embodiments, the functionality of the network entity 20 and the subscriber verification unit 72 may be achieved using a computing apparatus that has access to a code memory (not shown) which stores computer-readable program code for operation of the computing apparatus, in which case the computer-readable program code could be stored on a medium which is fixed, tangible and readable directly by the network entity 20 and the subscriber verification unit 72 (e.g., removable diskette, CD-ROM, ROM, fixed disk, USB drive), or the computer-readable program code could be stored remotely but transmittable to the network entity 20 and the subscriber verification unit 72 via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof.

While specific embodiments of the present invention have been described and illustrated, it will be apparent to those skilled in the art that numerous modifications and variations can be made without departing from the scope of the invention as defined in the appended claims.

What is claimed is:

1. A method implemented at a network entity, comprising:
a. receiving an indication of a selection made by a user while the user is viewing a stream of video content;
b. obtaining programming information regarding a program promoted in said stream of video content when the selection was made, the program being promoted during a promotional time slot of a television channel; and
c. causing the program to be captured for the user at least in part on the basis of the programming information regarding the program.

2. A method as defined in claim 1, wherein prior to causing the program to be captured, said method comprises storing at the network entity program capturing information on the basis of which the program is caused to be captured.

3. A method as defined in claim 2, wherein the program capturing information is generated at least in part on the basis of the programming information regarding the program.

4. A method as defined in claim 2, wherein the program capturing information comprises information indicative of a television channel on which the program is playing.

5. A method as defined in claim 2, wherein the program capturing information comprises information indicative of a time at which the program will be playing.

6. A method as defined in claim 2, wherein the program capturing information comprises information indicative of a recording device operative for recording the program.

7. A method as defined in claim 1, wherein causing the program to be captured comprises outputting a signal to a recording device operative for recording the program, the signal being output in response to at least one condition contained in the program capturing information.

8. A method as defined in claim 7, wherein the recording device comprises a network recording device.

9. A method as defined in claim 7, wherein the recording device comprises a television set top box.

10. A method as defined in claim 1, wherein causing the program to be captured comprises outputting a signal to a capturing device operative for causing the television channel to be changed, the signal being output in response to at least one condition contained in the program capturing information.

11. A method as defined in claim 10, wherein the capturing device is operative for providing a prompt to a user for causing the user to change the television channel.

12. A method as defined in claim 1, further comprising receiving from the user an identification of a device operative for capturing the program.

13. A method as defined in claim 1, wherein the indication of a selection made by the user, is made while the user is viewing the television channel.

14. A method as defined in claim 1, wherein the indication of a selection made by the user is provided via a remote control device.

15. A method as defined in claim 1, wherein the indication of a selection made by the user is provided via a personal computer on which the user is viewing the stream of video content.

16. A method as defined in claim 1, wherein the indication of a selection made by the user is provided via a remote communication device on which the user is viewing the stream of video content.

17. A method as defined in claim 1, wherein the programming information regarding the program is received at said network entity from a video content provider.

18. A method as defined in claim 17, wherein obtaining programming information regarding the program comprises receiving the programming information from the video content provider in response to a request from said network entity.

19. A method as defined in claim 17, wherein the programming information regarding the program is received from the video content provider together with programming information for a plurality of programs.

20. A method as defined in claim 19, wherein the programming information for the plurality of programs is stored in a memory of said network entity.

21. A method as defined in claim 20, wherein obtaining programming information regarding the program comprises retrieving from the memory of said network entity, the programming information regarding the program from the programming information for the plurality of programs.

22. A method as defined in claim 19, wherein the programming information received for the plurality of programs is received from the video content provider at periodic time intervals.

23. A network entity, comprising:
a. a communication unit operative for:
i. receiving an indication of a selection made by a user while the user is viewing a stream of video content;
ii. obtaining programming information regarding a program promoted in the stream of video content when the selection was made, the program being promoted during a promotional time slot of a television channel; and
b. a program capturing unit operative for causing the program to be captured for the user, at least in part on the basis of the obtained programming information.

24. A network entity as defined in claim 23, wherein prior to causing the program to be captured, said program capturing unit is further operative for storing program capturing information on the basis of which the program is caused to be captured.

25. A network entity as defined in claim 24, wherein the program capturing information is generated at least in part on the basis of the programming information regarding the program.

26. A network entity as defined in claim 24, wherein the program capturing information comprises information indicative of a television channel on which the program is playing.

27. A network entity as defined in claim 24, wherein the program capturing information comprises information indicative of a time at which the program will be playing.

28. A network entity as defined in claim 24, wherein the program capturing information comprises information indicative of a recording device operative for recording the program.

29. A network entity as defined in claim 24, wherein the program capturing unit is operative for outputting a signal to a recording device operative for recording the program, the signal being output in response to at least one condition contained in the program capturing information.

30. A network entity as defined in claim 29, wherein the recording device is a network recording device.

31. A network entity as defined in claim 29, wherein the recording device is a television set top box.

32. A network entity as defined in claim 23, wherein causing the program to be captured comprises outputting a signal to a capturing device operative for causing the television channel to be changed, the signal being output in response to at least one condition contained in the program capturing information.

33. A network entity as defined in claim 23, wherein the capturing device is operative for providing a prompt to a user for causing the user to change the television channel.

34. A network entity as defined in claim 23, wherein said communication unit is further operative for receiving from the user an identification of a device operative for capturing the program.

35. A network entity as defined in claim 34, wherein the device operative for capturing the program comprises a television set top box.

36. A network entity as defined in claim 23, wherein the indication of a selection made by the user, is made while the user is viewing a television channel.

37. A network entity as defined in claim 23, wherein the indication of a selection made by the user is provided via a remote control device.

38. A network entity as defined in claim 23, wherein the indication of a selection made by the user is provided via a personal computer on which the user is viewing the stream of video content.

39. A network entity as defined in claim 23, wherein the indication of a selection made by the user is provided via a remote communication device on which the user is viewing the stream of video content.

40. A network entity as defined in claim 23, wherein said communication unit is operative for receiving from a video content provider the programming information regarding the program.

41. A network entity as defined in claim 40, wherein obtaining programming information regarding the program comprises receiving the programming information from the video content provider in response to a request from said network entity.

42. A network entity as defined in claim 40, wherein the programming information regarding the program is received from the video content provider together with programming information for a plurality of programs.

43. A network entity as defined in claim 42, wherein said network entity further comprises a memory unit, wherein the programming information for the plurality of programs received from the video content provider is stored in said memory unit.

44. A network entity as defined in claim 43, wherein obtaining programming information regarding the program comprises retrieving from the programming information for the plurality of programs stored in said memory unit, the programming information regarding the program.

45. A network entity as defined in claim 42, wherein the programming information received for the plurality of programs is received at periodic time intervals.

46. A system comprising:
a. a network entity, comprising:
i. a communication unit operative for:
1. receiving an indication of a selection made by a user while the user is viewing a stream of video content;
2. obtaining programming information regarding a promoted program in said stream of video content when the selection was made, the program being promoted during a promotional time slot of a television channel; and
ii. a program capturing unit operative for:
1. storing program capturing information generated at least in part on the basis of the programming information regarding the program;
2. causing the program to be captured for the user on the basis of the program capturing information;
b. a capturing device in communication with said network entity, said capturing device being operative for capturing the program in response to a signal from said program capturing unit.

47. A system as defined in claim 42, wherein said program capturing unit is operative for outputting said signal in response to at least one condition contained in the program capturing information.

48. A system as defined in claim 42, wherein the indication of a selection made by the user is issued from a communication device on which the user is viewing the stream of video content, the communication device being different from said network entity and said capturing device.

49. A system as defined in claim 44, wherein said communication device is a personal computer.

50. A system as defined in claim 44, wherein said communication device is a mobile communication device.

51. A system as defined in claim 42, wherein said capturing device is a network recording device.

52. A system as defined in claim 42, wherein said capturing device is a television set top box.

53. A method implemented at a network entity, comprising:
a. receiving an indication of a selection made by a user while the user is viewing a stream of video content;
b. obtaining programming information regarding a program promoted in said stream of video content when the selection was made; and
c. causing the program to be recorded for the user at least in part on the basis of the programming information regarding the program.
